(19) United States
(12) Patent Application Publication
(10) Pub. No.: US 2012/0291502 A1
(43) Pub. Date: Nov. 22, 2012

(54) REMOTELY OPERABLE VEHICLE COMPARTMENT LOCK

(76) Inventors: Robert Paul Frankham, Tallebudgera (AU); Gary John Grevis, Nerang (AU)

(21) Appl. No.: 13/576,489

(22) PCT Filed: Feb. 4, 2011
(86) PCT No.: PCT/AU2011/000111

§ 371 Date: Aug. 1, 2012

(30) Foreign Application Priority Data
Feb. 5, 2010 (AU) 2010900459

(51) Int. Cl. E05B 47/06; E05B 65/12

(52) U.S. Cl. 70/279.1; 70/277

(57) ABSTRACT

A remotely operable lock for a vehicle compartment includes a rotary latch;
a detent moveable from a locked position to an unlocked position for preventing and allowing turning of the rotary latch;
an electrical actuator mechanically coupled to the detent to selectively move the detent from the locked position to the unlocked position; and
a key operated member arranged to selectively interfere with movement of the detent to thereby hold the detent in the locked position or the unlocked position irrespective of operation of the electrical actuator.

### TECHNICAL FIELD

The present invention relates to a lock that can be remotely operated and/or monitored. A particular application of the invention is for use as a lock for a utility vehicle cap or canopy.

### BACKGROUND

The reference to any specific prior art in the following discussion is not to be taken as any admission or evidence that the prior art forms part of the common general knowledge.

Many tradespeople make use of a utility vehicle in the course of their work. Such utility vehicles are often fitted with a canopy or “cap” over their rear tray to provide shelter and security for a tradesperson's tools which are stored therein. In one configuration, which is illustrated in FIG. 1, the canopy 1 includes one or more side doors 3. The side doors are hinged along a respective hinge line 5 and are held in the closed position, and if desired locked, by means of a lock assembly, the face plate 7 of which is visible in FIG. 1.

During the course of a busy day the tradesperson may make several visits to job sites and need to lock and unlock the side doors in order to retrieve and stow tools and supplies. A problem that arises is that the tradesperson, once within the vehicle cabin, may become unsure of the status of the door lock. Furthermore, if there are three locks, as is the case for the canopy shown in FIG. 1, then the tradesperson will have to manually unlock each of the doors in order to have complete access to the interior of the canopy. These problems are undesirable because they compromise the security of the canopy and they slow the tradesperson during the course of a day's work.

A further problem, where electrical locking systems are involved, is that the tradesperson may wish to lock or unlock the canopy whilst standing adjacent it and without having to firstly return to the cabin to electrically operate the locks.

It is an object of the present invention to provide a remotely operable lock that addresses one or more of the above problems.

### SUMMARY OF THE INVENTION

According to a first aspect of the present invention, there is provided a remotely operable lock for a vehicle compartment, including:
a rotary latch;
a detent moveable from a locked position to an unlocked position for preventing and allowing turning of the rotary latch;
an electrical actuator mechanically coupled to the detent to selectively move the detent from the locked position to the unlocked position; and
a manually operated member arranged to selectively interfere with movement of the detent to thereby hold the detent in the locked position or the unlocked position irrespective of operation of the electrical actuator.

Preferably the detent comprises a portion of a locking tongue.

The manually operated member may be arranged to rotate to a first position to force said tongue to bring the detent to the unlocked position and to a second position to force said tongue to bring the detent to the locked position.

Preferably the manually operated member is received within a triangular shaped aperture formed through the locking tongue.

The manually operated member may comprise a dog protruding from a key barrel of the lock.

In a preferred embodiment of the invention a first sensor is provided that can be monitored electrically and is arranged to be triggered by operation of the detent for sensing if the detent is in the locked or unlocked position.

The lock may further include a second sensor that can be monitored electrically and which is responsive to rotation of the rotary latch for indicating an open or closed state of the latch.

Preferably the first sensor comprises an electrical switch having an operation arm which lies across a path of a projection from the locking tongue.

Preferably the lock includes a shaft for turning the rotary latch, said shaft also bearing a cam having a step to engage the detent whilst the detent is in the locked position, wherein the cam and rotary latch rotate through a collinear axis.

In a preferred embodiment the second sensor comprises a switch that is arranged to be triggered by a dog projecting from the cam upon the cam rotating to thereby indicate rotation of the rotary latch.

Preferably the electrical actuator comprises a solenoid. In a preferred embodiment an arm of the solenoid is linked to the locking tongue via a lever for raising and lowering of the locking tongue in response to energisation and de-energisation of the solenoid.

Preferably the lock is coupled to a remote control module by wires interconnecting the remote control modules and one or more of the electrical actuator, first sensor and second sensor.

### BRIEF DESCRIPTION OF THE DRAWINGS

FIG. 1 is a view of a prior art utility vehicle canopy.

FIG. 2 is an exploded view of a remotely operable lock according to a preferred embodiment of the present invention.

FIG. 3 is a view of the rear and right hand side of the lock.

FIG. 4 is a view of the front of the lock.

FIG. 5 is a view of the front and left hand side of the lock.

FIG. 6 is a first diagram illustrating a first mode of operation of the lock wherein locking is controlled electrically.

FIG. 7 is a second diagram illustrating the first mode of operation.

FIG. 8 is a third diagram illustrating the first mode of operation.

FIG. 9 is a first diagram illustrating a second mode of the lock wherein the lock is manually unlocked.

FIG. 10 is a second diagram illustrating the second mode of operation.

FIG. 11 is a first diagram illustrating a third mode of the lock wherein the lock is manually locked.

FIG. 12 is a second diagram illustrating the third mode of operation of the lock.

FIG. 13 shows the front of the lock with the keyway turned anticlockwise to horizontal wherein the lock is in manual unlock configuration.

FIG. 14 shows the front of the lock with the keyway turned vertically wherein the lock is in a mode for electrical locking and unlocking operation.

FIG. 15 shows the front of the lock with the keyway turned clockwise to horizontal wherein the lock in manual lock configuration.

Preferred features, embodiments and variations of the invention may be discerned from the following Detailed Description which provides sufficient information for those skilled in the art to perform the invention.

The Detailed Description is not to be regarded as limiting the scope of the preceding Summary of the Invention in any way. The Detailed Description will make reference to a number of drawings as follows:

### DETAILED DESCRIPTION OF PREFERRED EMBODIMENTS

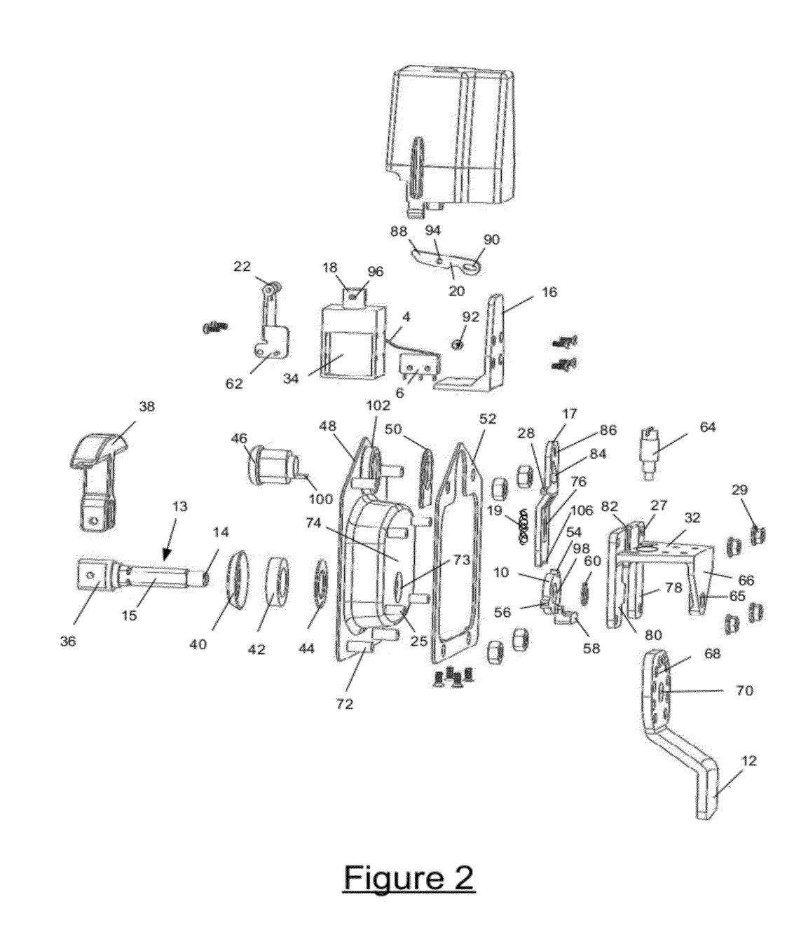

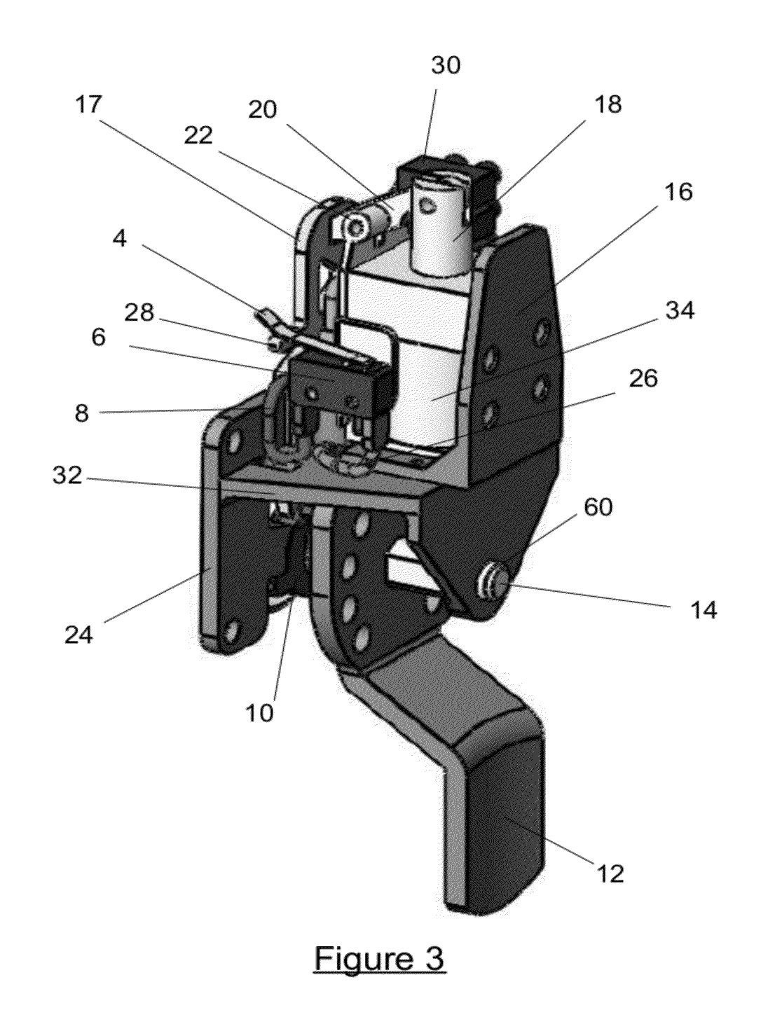

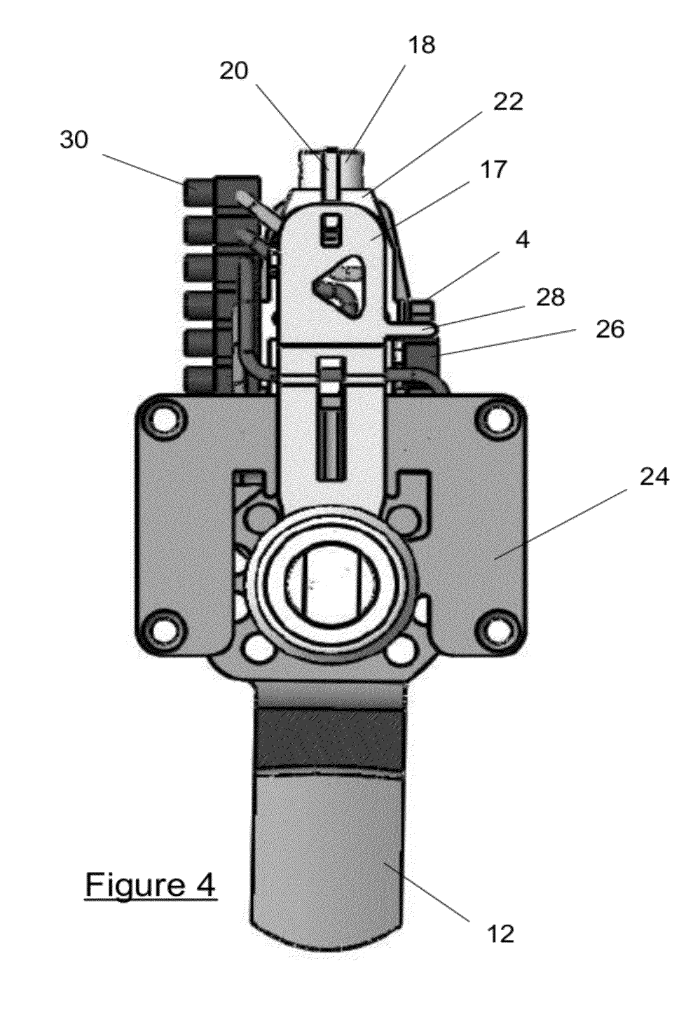

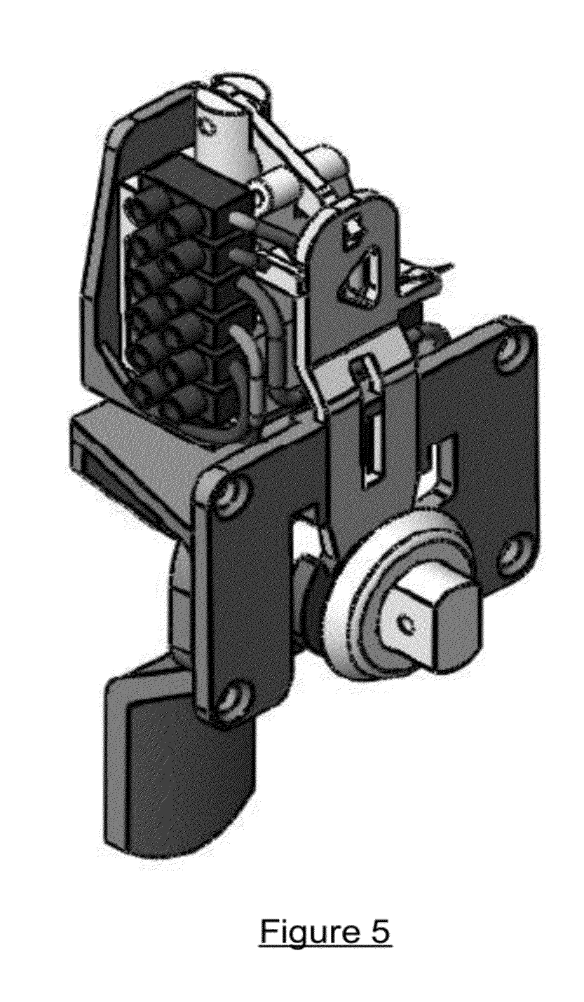

A remotely operable lock according to a preferred embodiment of the present invention will now be described with reference to FIG. 2, which is an exploded view, and FIGS. 3 to 5, which are various views of the assembled lock mechanism.

The preferred embodiment of the invention comprises a shaft 13, which has an intermediate portion 15 a proximal end 36 and a distal end 14. The intermediate portion 15 has flat sides while the distal end 14 is cylindrical. The proximal end 36 is pivotally linked to an operator handle 38. Shaft 13 passes through a stainless steel concave outer washer 40, a waterproof washer 42 and a flat washer 44, all located on an external side of faceplate 74. The shaft 13 further passes through a hole 73 formed in the faceplate 74 and thence through a central hole in cam 98. The hole in cam 98 is formed with flat sides to engage the flat sides the intermediate portion 15 of shaft 13. The cam 98 is located between legs 78 and 80 of mounting bracket 66. The shaft 13 then passes through a central aperture 70 formed through the 68 head of latch tongue 12. The central aperture 70 is formed with flat sides corresponding to the cross section of the intermediate portion 15 of shaft 13 so that the latch tongue can be rotated by turning of shaft 13.

The faceplate 74 is formed with a bore 48 that receives a key barrel 46. A rubber key barrel gasket 50 is provided that is formed with a hole to allow passage of the key barrel 46. The key barrel gasket 50 and faceplate gasket 52 surround a mounting hole formed through the canopy and are interposed between the faceplate 74 and the outside of the canopy.

The faceplate is bolted to mounting bracket 66 by means of its threaded legs 25 which pass through bolt holes 27 of the mounting bracket and are received by bolts 29.

The distal end 14 of shaft 13 is finally received in hole 65 of mounting bracket 66. A circlet 60 is fitted over the end of the shaft on the outside of bracket 66, as shown in FIG. 3, in order to prevent the shaft from withdrawing.

A locking tongue 17 is formed with offset upper and lower portions interconnected by a diagonal bridge. The lower portion of locking tongue 17 is received into a vertical slot 82 of mounting bracket 66.

The upper portion is formed with an upper lever slot 86 therethrough. Below the lever slot 86 there is formed a triangular hole 84 that receives a projection from the key barrel 46 in the form of dog 100. By rotating key barrel 46, with a key, key barrel dog 100 is moved in an arc across the triangular hole 84 from an unlocked position, where it is located against the vertical base of triangle 84 (as seen in FIGS. 7 and 8) a locked position where it occupies the apex 31 of the triangle. It will be realised that in the unlocked position the locking tongue is able to slide up and down, whereas when the key barrel dog 100 assumes the locked position, in the apex 31 of triangle 84, then the locking tongue 17 is prevented from moving.

A lower end of locking tongue 17 is formed as a cam follower 106. A coil spring 19 is located within a vertical spring slot 76 formed in the lower portion of locking tongue 17. An upper end of the spring finds purchase against mounting bracket 66, whereas the lower end engages the bottom of the spring slot 76. Consequently, the locking tongue 17, and so the cam follower 106, is biased down against the rim 10 of cam 98. The rim 10 of cam 98 is formed with a step 54 that abuts an outside edge of cam follower 106 when it is lowered against the cam rim.

Thus the cam can only be freely rotated by turning shaft 13 whilst the locking tongue is lifted clear of the cam. It will be realised that the outside edge of the cam follower 106 that abuts the step 54 comprises a detent (shown as item 53 in FIG. 7). A further step 56 is provided to abut the opposite outside edge of cam follower 106 to thereby prevent rotation in the opposite direction when in the locked configuration.

A dog 58 also extends from the side of cam 98. The dog 58 trips a sensor in the form of microswitch 64 when the cam is in a locked position. The microswitch 64 is seated through a hole formed through the upper face 32 of mounting bracket 66.

A solenoid bracket 16 is bolted to the top face 32 of mounting bracket 66. Fastened to solenoid bracket 16 is a solenoid 34 having an actuator arm 18 with a slotted head across which there extends a pin 96. Fastened to the side of the solenoid 34 there is a plate 62 from which extends a vertical fulcrum arm having a head 22 with an eye therethrough for receiving a pin 92. A lever 20 is provided that has an eye 90 which is connected the head of the solenoid by pin 96.

The lever 20 is further pivoted at its fulcrum eye 94 by the pin 92, which passes through the eye of fulcrum head 22. A free end 88 of lever 20 is engaged by lever slot 86 of locking tongue 17. Consequently, energising the solenoid 34 causes the arm 18 to extend upward thereby lifting free the end 88 of lever 20 and so lifting the locking tongue 17, which in turn lifts cam follower 106 and thus detent 53 free of cam 98 so that the cam, and hence the latch tongue 12, are free to rotate.

A locking tongue sensor 6 is fastened to the side of plate 62 adjacent the body of solenoid 34. The locking tongue sensor 6 comprises a switch having an operation arm 4 which extends from the body of the switch. The free end of operation arm 4 extends past a tab 28 that projects from the side of the locking tongue 17.

Accordingly, movement of the locking tongue from its upper position to its lower position causes the tab 28 to move the end of operation arm 4 thereby changing the state of the switch 6 from “on” to “off”. Consequently, the position of locking tongue 17 can be determined by monitoring the electrical status of locking tongue sensor 6. Similarly, the rotary status of cam 98, and hence rotary latch tongue 12, can be determined by monitoring the electrical status of microswitch 64.

In use, the terminals of the microswitch 64, the solenoid 34 and the locking tongue sensor 6 are wired to an electrical screw terminal 30. The electrical screw terminal 30 is provided to assist in terminating cables onto the lock assembly from the cabin of the vehicle.

The cables are provided to electrically communicate between the lock assembly and a monitoring and control module that is provided in the cabin for the vehicle's driver to operate. The control module includes controls for switching the solenoid 34 on and off. Provided that the key barrel 46 is rotated so that it does not hold the locking tongue 17 from rising or falling, remote energising of the solenoid will cause the locking tongue to rise thereby unlocking the cam so that the latch 12 is free to rotate. The position of the cam, and so of the rotary latch may then be determined by monitoring the status of microswitch 64.

For example, the microswitch status may be determined by checking an LED that is located in the control module and in circuit with the microswitch, to see if it is on or off. Similarly, the position of the locking tongue can also be determined by noting whether or not another LED, in circuit with the sensor 6, is lit or unlit corresponding to the locking tongue being either raised or lowered.

It may be noted that by unfastening the solenoid bracket 16 the electrical components of the lock assembly can be readily removed, thereby leaving a purely mechanical cam lock assembly in place.

Consequently the electrical components can be replaced in a modular fashion and faulty units readily disconnected and taken away for repair if necessary.

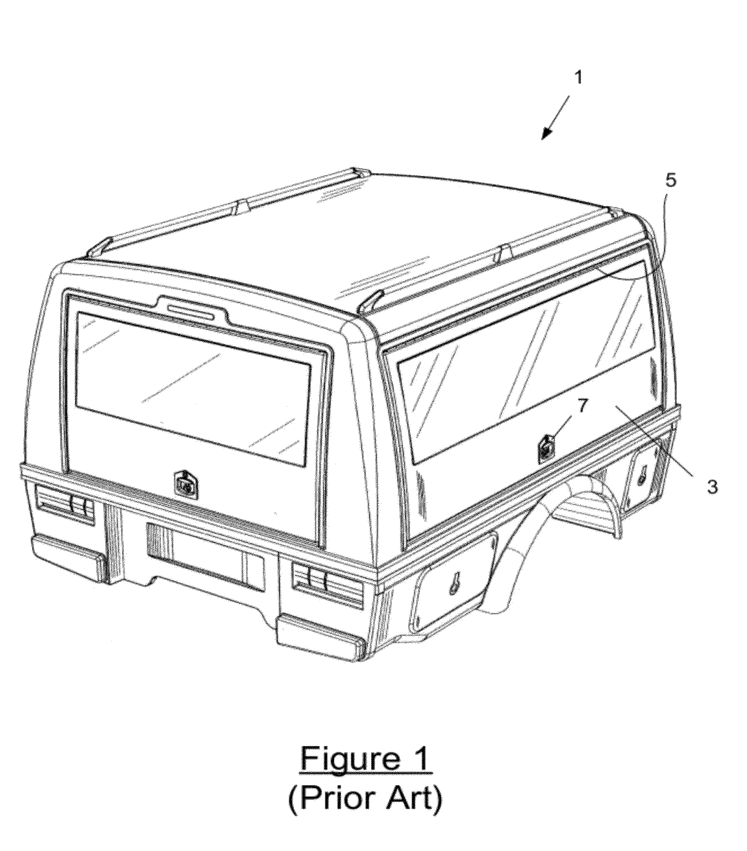

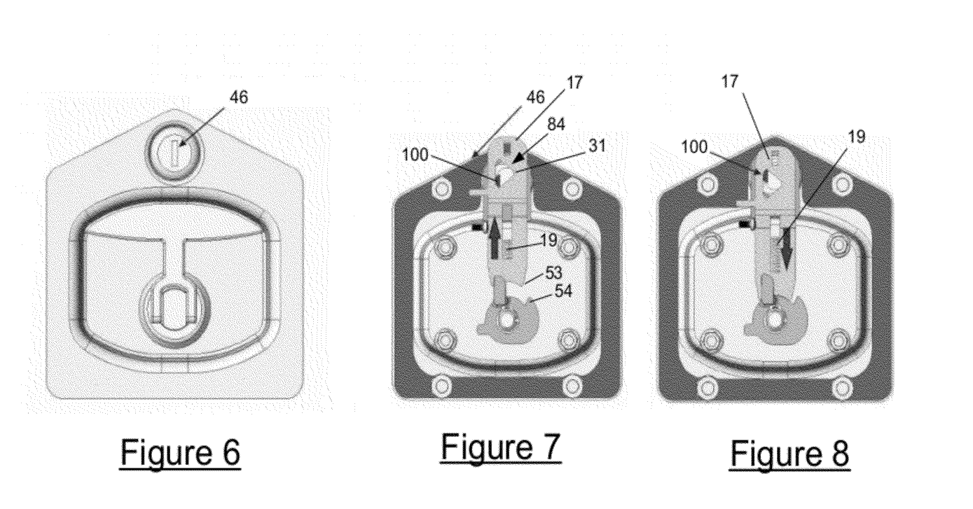

Referring now to FIGS. 6, 7 and 8, the key barrel dog 100 may be rotated so that it abuts the long vertical side of triangular hole 84 through the locking tongue 17. In this position, the locking tongue may be slid upward without interference from the key barrel dog 100, by operating solenoid 34. Operating solenoid 34 brings detent 53 free of cam 54 so that the cam 54, and hence latch tongue 12 (visible in FIG. 1) are free to rotate as shown in FIG. 7.

With the solenoid de-energised the spring 19 brings the locking tongue 17 downward so that detent 53 prevents cam 54, and hence latch tongue 12, rotating. Consequently, with the key barrel dog 100 brought to the position shown in FIGS. 6 to 8, the locking tongue 17, and hence locking of the lock assembly may be remotely controlled by operating the solenoid 34.

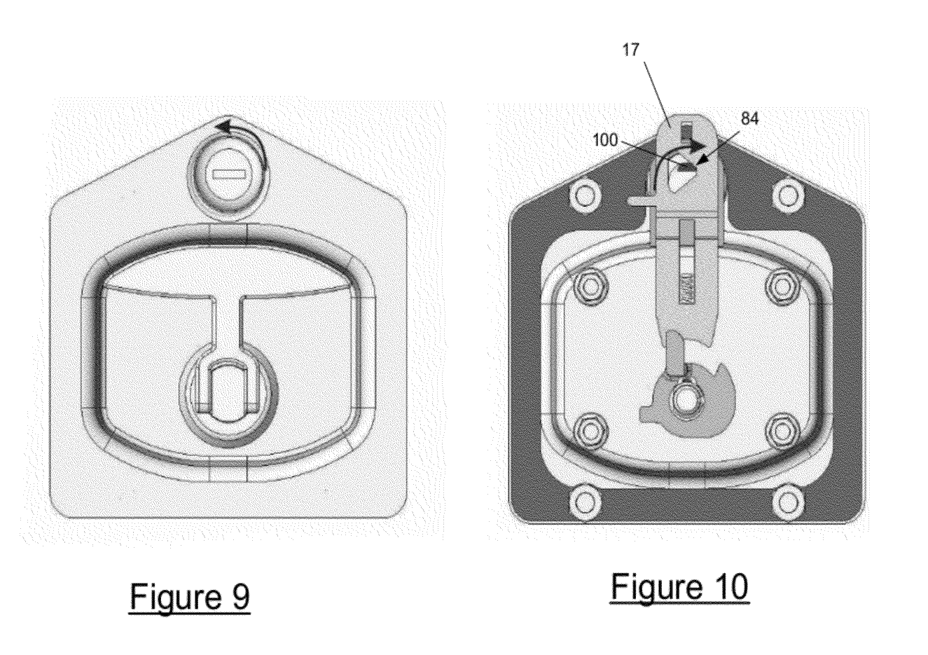

FIGS. 9 and 10 illustrate the situation where the key barrel dog 100, i.e. one form of a manually operated member, has been rotated through ninety degrees relative to its position in FIGS. 6 to 8 to bring it to its highest position and into abutment with the apex of the triangular slot opposite the long vertical side of said slot. In this position it interferes with movement of the locking tongue. Bringing the barrel dog 100 to this position also forces the locking tongue 17 upward thereby bringing the detent 53 clear of cam 54 and so manually holding it in the unlocked position irrespective of the operation of the solenoid.

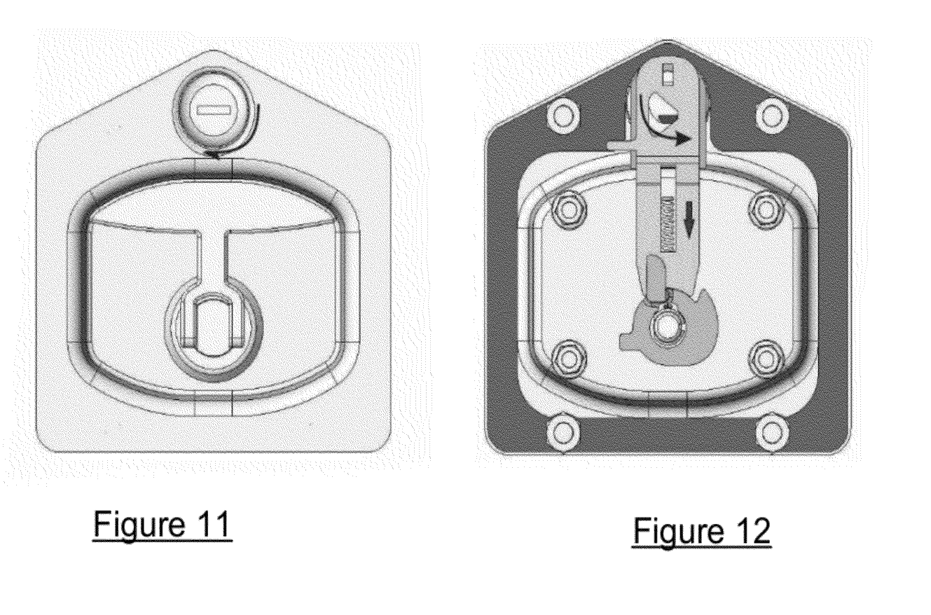

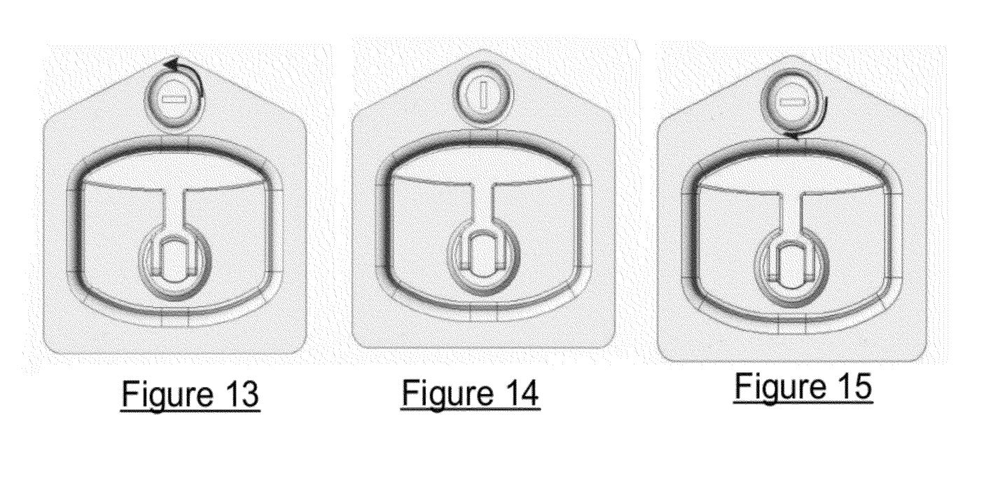

FIGS. 11 and 12 illustrate the situation where the key barrel dog 100 has been rotated through ninety degrees relative to its position in FIGS. 6 to 8 to bring it to its lowest position and into abutment with the apex of the triangular slot. In this position it once again interferes with movement of the locking tongue.

In doing so the barrel dog 100 forces the locking tongue 17 downward thereby bringing the cam follower against the cam 54 and so manually locking the lock assembly irrespective of the operation of the solenoid.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A remotely operable lock for a vehicle compartment, including:
a rotary latch;
a detent moveable from a locked position to an unlocked position for preventing and allowing turning of the rotary latch;
an electrical actuator mechanically coupled to the detent to selectively move the detent from the locked position to the unlocked position; and
a manually operated member arranged to selectively interfere with movement of the detent to thereby hold the detent in the locked position or the unlocked position irrespective of operation of the electrical actuator.

2. A lock according to claim 1, wherein the detent comprises a portion of a locking tongue.

3. A lock according to claim 2, wherein the manually operated member is arranged to rotate to a first position to force said tongue to bring the detent to the unlocked position and to a second position to force said tongue to bring the detent to the locked position.

4. A lock according to claim 2, wherein the manually operated member is received within a triangular shaped aperture formed through the locking tongue.

5. A lock according to claim 4, wherein the manually operated member comprises a dog protruding from a key barrel of the lock.

6. A lock according to claim 2 including a first sensor arranged to be monitored electrically and is arranged to be triggered by operation of the detent for sensing if the detent is in the locked or unlocked position.

7. A lock according to claim 6 including a second sensor that can be monitored electrically and which is responsive to rotation of the rotary latch for indicating an open or closed state of the latch.

8. A lock according to claim 7, wherein the first sensor comprises an electrical switch having an operation arm which lies across a path of a projection from the locking tongue.

9. A lock according to claim 8, including a shaft for turning the rotary latch, said shaft also engaging a cam having a step to catch the detent whilst the detent is in the locked position, wherein the cam and rotary latch rotate through a collinear axis.

10. A lock according to claim 9, wherein the second sensor comprises a switch that is arranged to be triggered by a dog projecting from the cam upon rotation of the cam to thereby indicate rotation of the rotary latch.

11. A lock according to claim 2, wherein the electrical actuator comprises a solenoid.

12. A lock according to claim 11, wherein an arm of the solenoid is linked to the locking tongue via a lever for raising and lowering of the locking tongue in response to energisation and de-energisation of the solenoid.
